(19) United States
(12) Patent Application Publication
(10) Pub. No.: US 2006/0130965 A1
(43) Pub. Date: Jun. 22, 2006

(54) Method and device for thermally activating heat-sensitive adhesive sheet, and printer equipped with this apparatus

(76) Inventors: Tatsuya Obuchi, Chiba-shi (JP); Minoru Hoshino, Chiba-shi (JP); Masanori Takahamashi, Chiba-shi (JP)

Correspondence Address: ADAMS & WILKS, 17 BATTERY PLACE, SUITE 1231, NEW YORK, NY, 10004, US

(21) Appl. No.: 11/288,739

(22) Filed: Nov. 29, 2005

(30) Foreign Application Priority Data
Dec. 13, 2004 (JP) 2004-359815

(51) Int. Cl. B32B 37/00

(52) U.S. Cl. 156/320; 156/359; 156/273.3

(57) ABSTRACT

The objectives of the present invention are to provide a device for the thermal activation of a heat-sensitive adhesive sheet, and a method therefor, that can improve the reliability with which the adhesive property of a heat-sensitive adhesive layer is manifested, and a printer that includes the device. According to the present invention, a thermal activation method, for manifestation of the adhesive quality of a heat-sensitive adhesive layer deposited on a heat-sensitive adhesive sheet, includes a step of: applying thermal energy, to locations on of the heat-sensitive adhesive sheet, that varies in consonance with the location.

### BACKGROUND OF THE INVENTION

1. Field of the Invention

The present invention relates to a method and a device, for thermally activating a heat-sensitive adhesive sheet, which is used, for example, as an adhesive label, wherein a heat-sensitive adhesive layer that normally is non-adhesive and that manifests adhesion when heated is deposited on one face of a sheet base material, and to a printer equipped with such a device. Particularly, the present invention relates to a method and a device for thermally activating a heat-sensitive adhesive sheet so as to increase the reliability with which the adhesion of the heat-sensitive adhesive layer is obtained, and to a printer quipped with this device.

2. Description of the Related Art

As one of the current sheets to be attached to products, there is a thermally activated sheet (e.g., a printed medium, such as a heat-sensitive adhesive sheet, on the surface of which a coated layer containing a thermally activated element is formed). This type of sheet is broadly employed for applications such as POS sheets for attachment to foods, distribution and delivery invoice sheets, medical record sheets, baggage tags, and labels for bottles and cans.

The heat-sensitive adhesive sheet is structured by depositing on one face of a sheet base material a heat-sensitive adhesive layer, which generally is non-adhesive but that manifests adhesion when heated, and by providing on the other face a printing enabled surface.

A printer for using the heat-sensitive adhesive sheet is proposed that includes a thermal activation device whereby a head, which has, as does a thermal head used as a print head for a thermal printer, a plurality of resistor members (heat generation elements) mounted on a ceramic substrate as heat sources, is brought in contact with a heat-sensitive adhesive sheet and heats a heat-sensitive adhesive layer (Japanese Patent Laid-Open Publication No. Hei 11 -79152).

The general configuration of a conventional printer used for a heat-sensitive adhesive sheet will now be explained while referring to FIG. 5.

The heat-sensitive adhesive sheet printer in FIG. 5 includes: a roll storage unit 20, for holding a heat-sensitive adhesive label tape 21 that has been wound to form a roll; a printing unit 30, for the printing of the heat-sensitive adhesive label tape 21; a cutting unit 40, for cutting the heat-sensitive adhesive label tape 21 into heat-sensitive adhesive sheets 60 having a predetermined length; and a thermal activation unit 50, which serves as a thermal activation device for thermally activating the adhesive property of the heat-sensitive adhesive layer of the heat-sensitive adhesive sheet 60.

The printing unit 30 includes: a thermal head 32, to be used for dot printing, provided with a plurality of heat generation elements 31, multiple comparatively small resistor members, that are arranged in the widthwise direction (perpendicular to the tape conveying direction) of the heat-sensitive adhesive label tape 21; and a platen roller 33, used for printing, that is to be pressed against the thermal head 32 (the heat generation elements 31). In. FIG. 5, the platen roller 33, as used for printing, is rotated clockwise, and the heat-sensitive adhesive label tape 21 is conveyed to the right.

The cutting unit 40 is a device for cutting, to appropriate lengths, the heat-sensitive adhesive label tape 21 that has been printed by the printing unit 30, and includes a movable blade 41, which is operated by a drive source (not shown) such as an electric motor, and a fixed blade 42, which is positioned opposite the movable blade 41.

The thermal activation unit 50 includes: a thermal head 52, for thermal property activation, that serves as heating means and that has a plurality of heat generation elements 51 that are arranged, as are the heat generation elements 31, in the widthwise direction (perpendicular to the conveying direction) of the heat-sensitive adhesive sheet 60; and a platen roller 53, for thermal property activation, that serves as conveying means for conveying the heat-sensitive adhesive label tape 21; and insertion rollers 54, which insert the heat-sensitive adhesive label tape 21 fed by the printing unit 30 between the thermal head 52 (heat generation elements 51) and the platen roller 53. In FIG. 5, the platen roller 53, for thermal property activation, is rotated for printing in the direction (counterclockwise in FIG. 5) opposite that of the platen roller 33, and feeds the heat-sensitive adhesive label tape 21 in a predetermined direction (to the right in FIG. 5).

According to the heat-sensitive adhesive sheet printer configured as described above, the thermal head 52 heats a heat-sensitive adhesive sheet 60, cut to a predetermined length by the cutting unit 40, to thermally activate the adhesive property of the heat-sensitive adhesive layer deposited thereon.

To ensure that appropriate adhesion is manifested by the heat-sensitive adhesion layer, the quantity of heat provided must neither fall below nor exceed a specific range.

The quantity of heat applied to the heat-sensitive adhesive sheet 60 by the heat generation elements 51 is emitted and spread in the in-plane direction of the heat-sensitive adhesive sheet 60. Conventionally, in order for the appropriate adhesion of the heat-sensitive adhesive layer to be manifested in the above described state, the quantity of heat generated by each heat generation element 51 is determined and is defined as a constant, regardless of which portion of the heat-sensitive-adhesive sheet 60 is to be heated.

As described above, for the conventional heat-sensitive adhesive sheet printer, the quantity of heat generated by all of the heat generation elements 51 that heat the heat-sensitive adhesive sheet 60 is determined to be a constant, regardless of which portion of the heat-sensitive adhesive sheet 60 is to be heated. The quantity of heat is defined so that for the heat-sensitive adhesive layer, appropriate adhesion can be manifested while heat is dispersed in the in-plane direction, as described above. However, since less heat is discharged at the end portions of the heat-sensitive adhesive sheet 60 than at the center portion, when an-equal amount of heat is generated by each of the heat generation elements 51, at the ends of the heat-sensitive adhesive sheet 60 the temperature would be higher than at the center. As a result, adhesion can not be appropriately manifested at the ends or in the center of the heat-sensitive adhesive sheet 60.

Generally, a quantity of heat is selected so that appropriate adhesion can be manifested in the center portion of an heat-sensitive adhesive sheet 60 having a larger area. In this case, however, extra heat is applied at the end portions of the heat-sensitive adhesive sheet 60, and appropriate adhesion can not be manifested. The end portions are the most important areas for heat-sensitive adhesive sheets 60 that are to be used as POS sheets for foods, as distribution or delivery sheets, as medical record sheets, as baggage tags or as bottle or can labels, and when appropriate adhesion is not manifested in these areas, the sheets can easily be peeled off.

Furthermore, as shown in FIG. 5, when the obverse face of the heat-sensitive adhesive layer is a printing enabled face, extra heat can cause unintended color development to occur on the printing enabled face.

### SUMMARY OF THE INVENTION

To resolve the above described problems of the conventional technique, the objectives of the present invention are to provide a device for the thermal activation of a heat-sensitive adhesive sheet, and a method therefor, that can improve the reliability with which the adhesive property of a heat-sensitive adhesive layer is manifested, and a printer that includes the device.

According to one aspect of the present invention, a thermal activation method, for manifestation of the adhesive quality of a heat-sensitive adhesive layer deposited on a heat-sensitive adhesive sheet, comprises a step of:

applying thermal energy, to locations on of the heat-sensitive adhesive sheet, that varies in consonance with the location.

As described above, since the thermal energy applied varies in accordance with the location on the heat-sensitive adhesive sheet, even when, thereafter, a heat discharging state differs, depending on the location, a large increase in the temperature due to extra thermal energy can be prevented.

In this case, the thermal energy applied to the end portions of the heat-sensitive adhesive sheet may be less than that applied to the center portion.

Further, the distribution of the thermal energy applied in a vertical direction relative to the heat-sensitive adhesive sheet may have a substantially trapezoidal shape.

Furthermore, the distribution of the thermal energy applied in a horizontal direction relative to the heat-sensitive adhesive sheet may have a substantially trapezoidal shape.

According to another aspect of the present invention, a thermal activation device for a heat-sensitive adhesive sheet comprises:

a thermal head, used for thermal activation, wherein a plurality of heat generation elements are arranged facing the heat-sensitive adhesive layer of the heat-sensitive adhesive sheet; and

a controller, for controlling heat generated by the individual heat generation elements so that, in consonance with locations on the heat-sensitive adhesive sheet, different quantities of thermal energy are applied to the heat-sensitive adhesive sheet by the heat generation elements.

In this case, the plurality of heat generation elements may be arranged so as to cover the entire heat-sensitive adhesive sheet.

The thermal activation device may further comprise:

a conveying unit, for conveying the heat-sensitive adhesive sheet,

wherein the plurality of heat generation elements are arranged perpendicular to the direction in which the heat-sensitive adhesive sheet is conveyed by the conveying unit.

The thermal activation device may further comprise:

a conveying unit, for conveying the heat-sensitive adhesive sheet,

wherein the plurality of heat generation elements are arranged in the direction in which the heat-sensitive adhesive sheet is conveyed by the conveying unit, and in the direction perpendicular to that.

The controller may control the quantity of the heat generated by individual heat generation elements, so that the thermal energy applied to the end portions of the heat-sensitive adhesive sheet is less than the thermal energy applied to the center portion.

The controller may control the quantity of heat generated by individual heat generation elements, so that the distribution of thermal energy applied in a vertical direction, relative to the heat-sensitive-adhesive sheet, has a substantially trapezoidal shape.

The controller may control the quantity of heat generated by individual heat generation elements, so that the distribution of thermal energy applied in a horizontal direction, relative to the heat-sensitive adhesive sheet, has a substantially trapezoidal shape.

According to the present invention, a printer comprises: a thermal activation device, for a heat-sensitive adhesive sheet according to this aspect, and a printing device.

Since the present invention is constituted as described above, the following effects can be obtained.

A large increase in the temperature due to extra thermal energy can be prevented, and the adhesive property of the heat-sensitive adhesive layer can be manifested appropriately. As a result, the reliability with which the adhesive property of the heat-sensitive adhesive layer is manifested can be increased.

### BRIEF DESCRIPTION OF THE DRAWINGS

FIG. 1 is a schematic diagram showing the configuration of a thermal activation device according to the present invention;

FIG. 2 is a block diagram showing the configuration of the control system of the thermal activation device in FIG. 1;

FIG. 3 is a flowchart showing the control operation for the thermal activation device in FIG. 1;

FIG. 4 is a diagram for explaining heating control according to the present invention; and

FIG. 5 is a block diagram showing the configuration of a printer used for a heat-sensitive adhesive sheet.

### DETAILED DESCRIPTION OF THE PREFERRED EMBODIMENT

The preferred embodiment of the present invention will now be described while referring to the accompanying drawings.

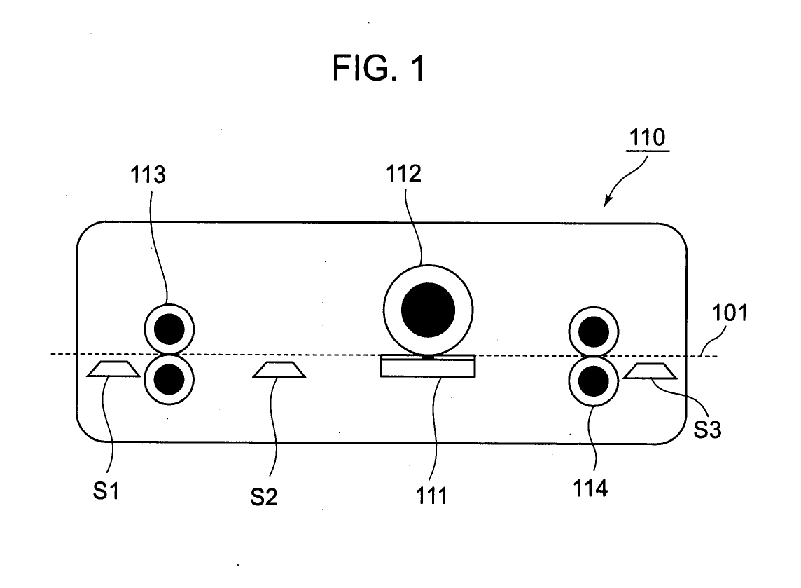

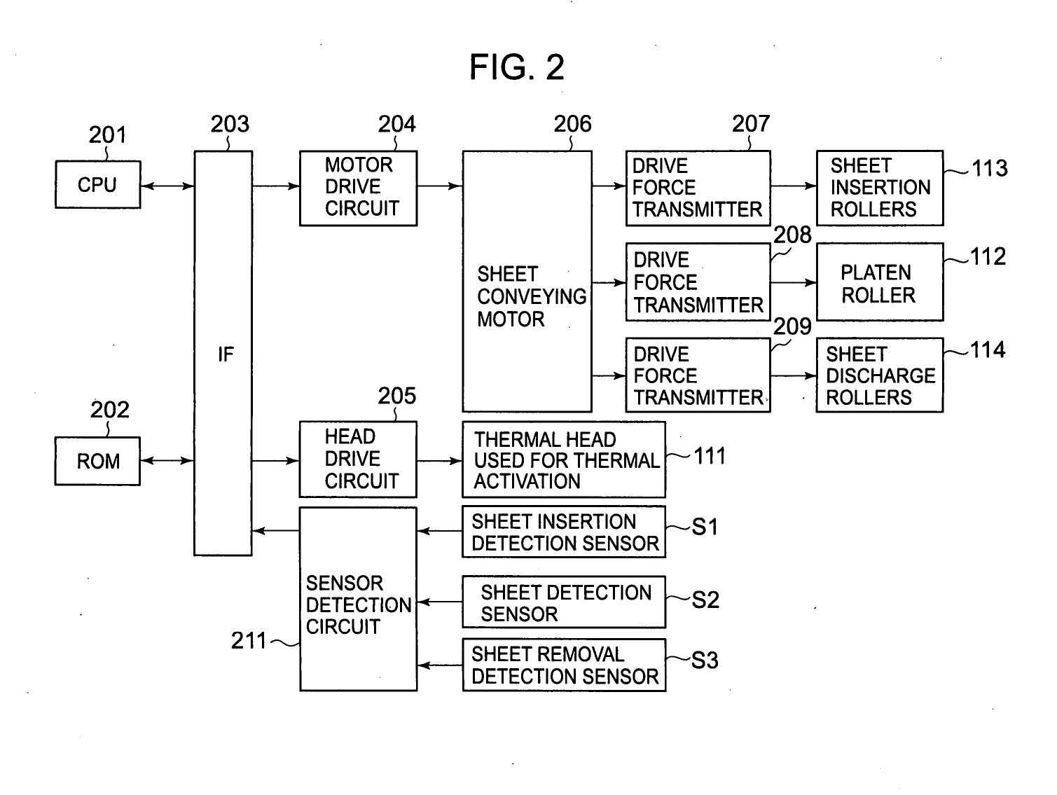

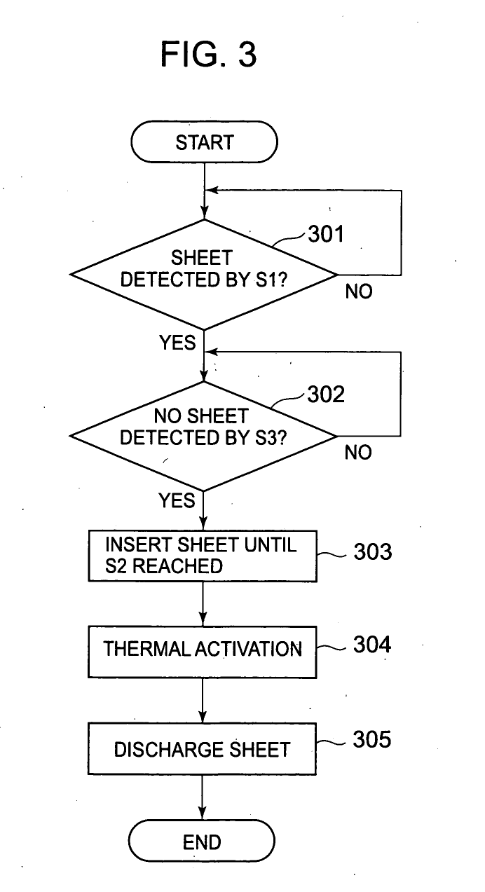

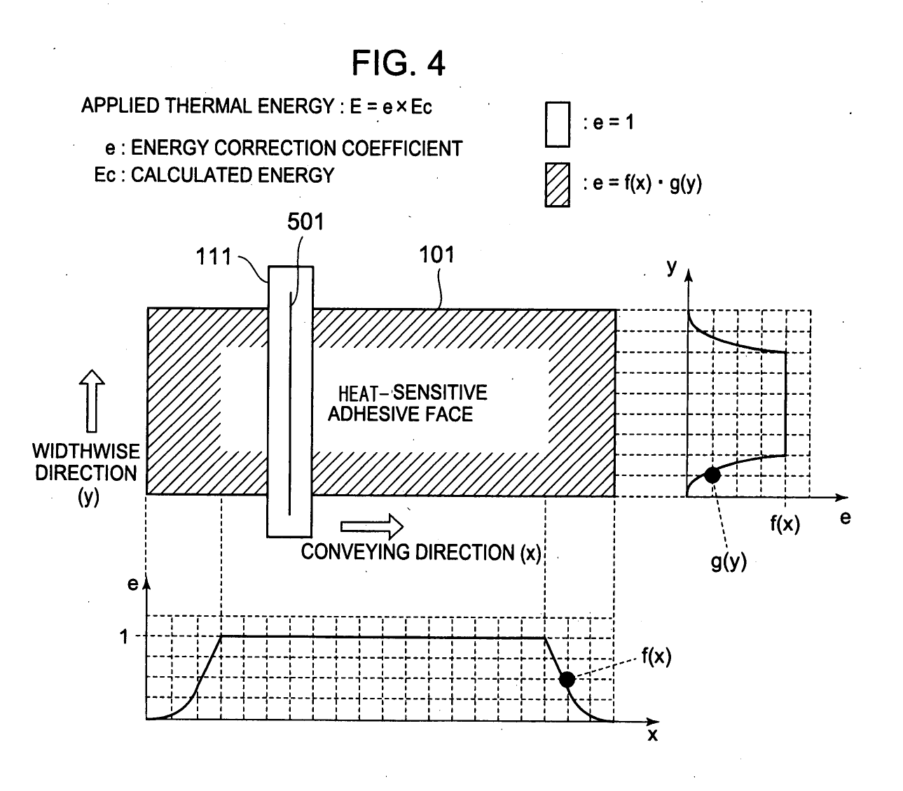

FIG. 1 is a schematic diagram showing the configuration of a thermal activation device according to the present invention, FIG. 2 is a block diagram showing the configuration of the control system of the thermal activation device in FIG. 1, FIG. 3 is a flowchart showing the control operation performed by the control system, and FIG. 4 is a diagram for explaining heating control according to the present invention.

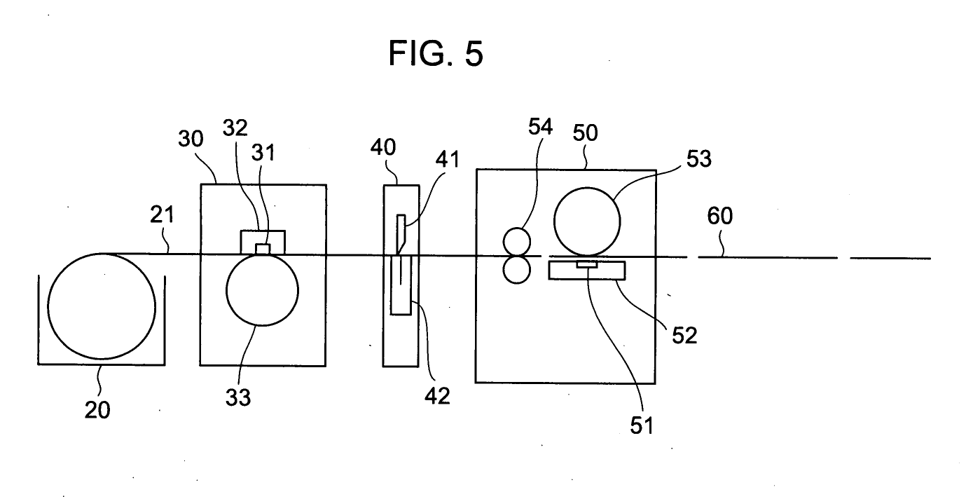

Only a thermal activation device 110 is shown in FIG. 1. However, according to the embodiment, and as in the conventional example shown in FIG. 5, a roll storage unit, a printing unit and a cutting unit are additionally provided for a printer that, in accordance with this invention, is equipped with the thermal activation device 110 in FIG. 1. But since the other components are the same as the roll storage unit 20, the printing unit 30 and the cutting unit 40 shown in FIG. 5, they are not shown, and no explanation for them will be given.

The thermal activation device 110 is a device for manifesting the adhesive property of a heat-sensitive adhesive sheet 101, and includes: a thermal head 111 used for thermal activation; platen roller 112, which is to be pressed against the thermal head 111; sheet insertion rollers 113 and sheet discharge rollers 114, which are used to convey the heat-sensitive adhesive sheet 101; and a sheet insertion detection sensor S1, a sheet detection sensor S2 and a sheet removal detection sensor S3, which collectively detect the position of a heat-sensitive adhesive sheet 101.

The heat-sensitive adhesive sheet 101 enters, and is conveyed inside, the thermal activation device 110 after being drawn in by the sheet insertion rollers 113. Thereafter, the face of the heat-sensitive adhesive sheet 101 on which a heat-sensitive adhesive layer is deposited (the lower side in FIG. 1) is heated, between the thermal head 111, used for thermal activation, and the platen roller 112, to activate the adhesive property of the heat-sensitive adhesive layer. Then, the sheet discharge rollers 114 discharge the heat-sensitive adhesive sheet 101 outside the thermal activation device 110. During the performance of this process, the position of the heat-sensitive adhesive sheet 101 in the thermal activation device 110 is detected by the sheet insertion detection sensor S1, the sheet detection sensor S2 and the sheet removal detection sensor S3, and a control operation consonant with the detected position is performed.

As shown in FIG. 4, the thermal head 111, the heating means, includes a heat generation member 501, formed of a plurality of heat generation elements that are arranged in the widthwise direction (perpendicular to the conveying direction) of the heat-sensitive adhesive sheet 101, and in this embodiment, the quantity of heat generated by each heat generation element is controlled in accordance with the arrangement. Specifically, the structure of the thermal head 111 used for thermal activation is the same as that of a printing head, used for a well known thermal printer, for which a glass ceramics protective film is deposited on the obverse surfaces of multiple heat-generating resistor members formed on a ceramic substrate using a thin-film deposition technique .

The type of heat-sensitive adhesive sheet 101 used in this embodiment is not especially limited. And may be a heat-sensitive adhesive sheet having the structure described, for example, in Japanese Patent Laid-Open Publication No. Hei 11-79152, where an insulating layer and a heat-sensitive color developing layer (a printing enabled layer) having the shape of a label are formed on the obverse surface of a base member and a heat-sensitive adhesive layer is formed on the reverse surface by the application and drying of a heat-sensitive adhesive agent. It should be noted that the heat-sensitive adhesive layer is made of a heat-sensitive adhesive agent that contains, as its main element, a thermoplastic resin or a solid plastic resin. The heat-sensitive adhesive-sheet 101 may also be one for which an insulating layer is not included, or may one for which a protective layer, or a color printed layer (a layer on which printing has previously been performed), is deposited on the surface of a heat-sensitive color developing layer.

The arrangement of the control system according to this embodiment will now be explained while referring to FIG. 2.

The control system includes: a CPU 201, a ROM 202, an interface (IF) 203, a motor drive circuit 204, a head drive circuit 205, a sheet conveying motor 206, drive force transmitters 207 to 209 and a sensor detection circuit 211.

The CPU 201 is connected via the IF 203 to the motor drive circuit 204, the head drive circuit 205 and the sensor detection circuit 211, and exercises control using a program stored in the ROM 202.

The drive force transmitters 207.to 209 are located between the sheet conveying motor 206 and the individual rollers, i.e., the sheet insertion rollers 113, the platen roller 112 and the sheet discharge rollers 114, and transmit the drive force produced by the sheet conveying motor 206 to the individual rollers to rotate these rollers. The transmission state of the drive force by the drive force transmitters 207 to 209 and the driving of the sheet conveying motor 206 are controlled by the motor drive circuit 204. In accordance with control signals received from the CPU 201 via the IF 203, the motor drive circuit 204 controls the transmission state of the drive force by the transmitters 207 to 209 and drives the sheet conveying motor 206.

The head drive circuit 205 controls the conductive state of the heat generation member 501 of the thermal head 111 in accordance with a signals received from the CPU 201 via the IF 203.

The sensor detection circuit 211 receives the output of the sheet insertion detection sensor S1, the sheet detection sensor S2 and the sheet removal detection sensor S3, and transmits the contents via the IF 203 to the CPU 201. In accordance with the position of the heat-sensitive adhesive sheet 101 indicated by the detection contents of the sensors S1 to S3, the CPU 201 transmits control signals to the motor drive circuit 204 and the head drive circuit 205 to move the heat-sensitive adhesive sheet 101 and to start thermal activation.

The thermal activation operation in this embodiment will now be described while referring to the flowchart in FIG. 3.

The CPU 201 determines, based on the output of the sheet insertion detection sensor S1, whether the heat-sensitive adhesive sheet 101 has been inserted (step 301). When the CPU 201 determines that the heat-sensitive adhesive sheet 101 is present, the CPU 201 determines, based on the output of the sheet removal detection sensor S3, whether the heat-sensitive adhesive sheet 101 that previously was thermally activated has been discharged from the thermal activation device 110 (step 302). When the CPU 201 determines that the heat-sensitive adhesive sheet 101 that previously was thermally activated has been discharged from the thermal activation device 110, the CPU 201 moves the heat-sensitive adhesive sheet 101, which has been inserted by the sheet insertion roller 113, until it is detected by the sheet detection sensor S2 (step 303). Sequentially, using the sheet insertion rollers 113 and the platen roller 112, the heat-sensitive adhesive sheet 101 is moved above the thermal head 111 used for thermal activation, and the thermal activation process is performed during which the heat generation member 501 of the thermal head 111 is rendered conductive for generating heat, so that the heating of the heat-sensitive adhesive sheet 101 is performed (step 304). Thereafter, the sheet discharge process is performed, during which the sheet discharge rollers 14 discharge the heat-sensitive adhesive sheet 101 outside the thermal activation device 110 (step 305).

While referring to FIG. 4, an explanation will now be given for the thermal activation processing performed using the thermal head 111 of this embodiment.

As previously described, when the heat-sensitive adhesive sheet 101 is uniformly heated, the quantity of heat discharged is smaller at the end portions of the heat-sensitive adhesive sheet 101 than at the center portion. Thus, when the heat quantities generated by the heat generation elements are equal, the temperature at the end portions of the heat-sensitive adhesive sheet 101 is higher than at the center portion. In this embodiment, the quantity of heat generated by the heat generation member 501 to heat the end portions of the heat-sensitive adhesive sheet 101 is so designated that it is smaller than the quantity of heat generated for the center portion.

As shown in FIG. 4, as the quantity of heat generated by the heat generation member 501, thermal energy E applied to the heat-sensitive adhesive sheet 101 by the heat generation member 501 is represented by the following expression.
E=e×Ec

In this expression, Ec denotes the calculated energy, which is calculated so that appropriate adhesion can be obtained at the center portion (solid-white portion in FIG. 4) of the heat-sensitive adhesive face of the heat-sensitive adhesive sheet 101 where heat is satisfactorily discharged; and e denotes an energy correction coefficient. The energy correction coefficient e is used to represent a difference in the thermal energy applied at the center portion and in the thermal energy applied at the end portions, whereat the quantity of heat discharged is smaller. The energy correction efficient is defined as a value obtained by adding a function f(x), related to the conveying direction (the horizontal direction) for the heat-sensitive adhesive sheet 101, to a function g(y), related to the widthwise direction (the vertical direction) perpendicular to the conveying direction. Functions f(x) and g(y) both have profiles that are substantially trapezoidal in shape and for which the upper base, corresponding to the center portion, is “1”. By adding together the functions f(x) and g(y), different and precise heating processes, consonant with the location, can be performed for the heat-sensitive adhesive sheet 101, and during the thermal activation process, the resulting temperature will be uniform across the face on which appropriate adhesion is to be obtained. Thus, a satisfactory adhesive quality can be manifested. And further, since the temperature is not increased until it is higher than necessary, unintended color development will not occur, even if the reverse face is a heat-sensitive printing face.

In the explanation for this embodiment, the thermal activation device has been applied for a printing apparatus of a thermal transferring type, such as a thermal printer. However, the present invention can also be applied for an ink jet printer and a laser printer. In such a case, for the printing of labels, instead of a heat-sensitive printing layer, an appropriate printing enabled layer can be deposited for the printer type that is employed.

Further, in this embodiment, a plurality of heat generation elements formed on the thermal head 111 used for thermal activation have been arranged in line, in the widthwise direction (perpendicular to the conveying direction) of the heat-sensitive adhesive sheet 101. However, other arrangements may be used. For example, heat generation elements also may be arranged like a belt, in the conveying direction, or may be arranged across a plane, so they cover an entire heat-sensitive adhesive sheet 101.

Furthermore, in the embodiment the thermal energy applied to the end portions of the heat-sensitive adhesive sheet 101 has been set so it is smaller than the thermal energy applied to the center portion. However, the level of the thermal energy applied is not thereby limited, and in practice depends the heat discharge state, which differs in accordance with the materials that constitute the thermal activation device 110. For example, when the material for the platen roller 112 that contacts the heat-sensitive adhesive sheet 101 has a higher thermal conductivity than does the material for the heat-sensitive adhesive sheet 101, a more preferable heat discharge is obtained at the end portions of the heat-sensitive adhesive sheet 101 than at the center portion. Thus, when an equal quantity of heat is generated by each of the heat generation elements, it is predicted that the temperature at the end portions will be lower than at the center portion. In this case, a determination is made to ascertain the quantity of heat generated by the individual heat generation elements, so that the thermal energy applied at the end portions of the heat-sensitive adhesive sheet 101 can be increased until it exceeds the thermal energy applied at the center portion.

What is claimed is:

1. A thermal activation method, for manifestation of the adhesive quality of a heat-sensitive adhesive layer deposited on a heat-sensitive adhesive sheet, comprising a step of:
applying thermal energy, to locations on of the heat-sensitive adhesive sheet, that varies in consonance with the location.

2. A thermal activation method according to claim 1, whereby the thermal energy applied to the end portions of the heat-sensitive adhesive sheet is less than that applied to the center portion.

3. A thermal activation method according to claim 1, whereby the distribution of the thermal energy applied in a vertical direction relative to the heat-sensitive adhesive sheet has a substantially trapezoidal shape.

4. A thermal activation method according to claim 1, whereby the distribution of the thermal energy applied in a horizontal direction relative to the heat-sensitive adhesive sheet has a substantially trapezoidal shape.

5. A thermal activation device, for manifestation of the adhesive quality of a heat-sensitive adhesive layer deposited on a heat-sensitive adhesive sheet, comprising:
a thermal head, used for thermal activation, wherein a plurality of heat generation elements are arranged facing the heat-sensitive adhesive layer of the heat-sensitive adhesive sheet; and
a controller, for controlling heat generated by the individual heat generation elements so that, in consonance with locations on the heat-sensitive adhesive sheet, different quantities of thermal energy are applied to the heat-sensitive adhesive sheet by the heat generation elements.

6. A thermal activation device according to claim 5, wherein the plurality of heat generation elements are arranged so as to cover the entire heat-sensitive adhesive sheet.

7. A thermal activation device according to claim 5, further comprising:
a conveying unit, for conveying the heat-sensitive adhesive sheet,
wherein the plurality of heat generation elements are arranged perpendicular to the direction in which the heat-sensitive adhesive sheet is conveyed by the conveying unit.

8. A thermal activation device according to claim 5, further comprising:
a conveying unit, for conveying the heat-sensitive adhesive sheet,
wherein the plurality of heat generation elements are arranged in the direction in which the heat-sensitive adhesive sheet is conveyed by the conveying unit, and in the direction perpendicular to that.

9. A thermal activation device according to claim 5, wherein the controller controls the quantity of the heat generated by individual heat generation elements, so that the thermal energy applied to the end portions of the heat-sensitive adhesive sheet is less than the thermal energy applied to the center portion.

10. A thermal activation device according to claim 5, wherein the controller controls the quantity of heat generated by individual heat generation elements, so that the distribution of thermal energy applied in a vertical direction, relative to the heat-sensitive adhesive sheet, has a substantially trapezoidal shape.

11. A thermal activation device according to claim 5, wherein the controller controls the quantity of heat generated by individual heat generation elements, so that the distribution of thermal energy applied in a horizontal direction, relative to the heat-sensitive adhesive sheet, has a substantially trapezoidal shape.

12. A printer comprises: a thermal activation device according to claim 5; and
a printing device.
